(19) United States
(12) Patent Application Publication
(10) Pub. No.: US 2011/0118963 A1
(43) Pub. Date: May 19, 2011

(54) METHOD FOR STARTING AN INTERNAL COMBUSTION ENGINE

(75) Inventors: PETER BAUR, MOENSHEIM (DE); SERGE NASSIF, KILSTETT (FR)

(73) Assignee: DR. ING. H.C. F. PORSCHE AKTIENGESELLSCHAFT, STUTTGART (DE)

(21) Appl. No.: 12/917,508

(22) Filed: Nov. 2, 2010

(30) Foreign Application Priority Data
Nov. 13, 2009 (DE) 10 2009 053 284.6

(51) Int. Cl. F02D 28/00

(52) U.S. Cl. 701/113

(57) ABSTRACT

In a method for starting an internal combustion engine of a motor vehicle which is connected to a transmission via a starting device and operated in a start/stop operating mode, a hydraulic medium is fed to the starting device via a valve device by a hydraulic pump. Before and during starting of the internal combustion engine by use of a starter, a control unit actuates the valve device in such a way that the valve device enables delivery of the hydraulic medium to the starting device. The control unit actuates the hydraulic pump in such a way that during the starting of the internal combustion engine the hydraulic pump delivers the hydraulic medium directly into the starting device in order to bring about a mechanical operative connection between the internal combustion engine and the transmission by the starting device.

### CROSS-REFERENCE TO RELATED APPLICATION

This application claims the priority, under 35 U.S.C. §119, of German application DE 10 2009 053 284.6, filed Nov. 13, 2009; the prior application is herewith incorporated by reference in its entirety.

### BACKGROUND OF THE INVENTION

### Field of the Invention

The invention relates to a method for starting an internal combustion engine of a motor vehicle which is connected to a transmission via a starting device and operated in a start/stop operating mode. A hydraulic medium is fed to the starting device via a valve device by a hydraulic pump.

There has recently been a tendency for automobile manufacturers to reintroduce the start/stop function for internal combustion engines of motor vehicles which was already introduced in the 1980s, that is to say the function according to which the internal combustion engine is shut down during a brief stop of the motor vehicle, for example at traffic lights or in a traffic jam and restarted when necessary, which is usually indicated by activation of the accelerator pedal. However, when the motor vehicle is started, which is usually carried out by closing the mechanical operative connection between the internal combustion engine and a transmission by a starting device, for example a wet clutch, there are in some cases delays since the starting device must first be filled with a hydraulic medium, usually oil, before the motor vehicle which is equipped with the internal combustion engine can start.

The prior art disclosed various approaches to a solution which are intended to eliminate this problem. For example, published, non-prosecuted German patent application DE 102 48 454 A1, corresponding to U.S. Pat. No. 6,776,739, describes that at first a hydraulic system of a starting device is to be activated or filled before the internal combustion engine is started. However, the force transmission system described in the document requires an electric motor or generator which drives a hydraulic pump in order to fill the hydraulic system. Until the hydraulic system is completely operationally ready, the internal combustion engine is not fired and no fuel is fed thereto. In addition, when the internal combustion engine starts, even the output power thereof is reduced by an ignition time offset and at least some of the inlet valves and outlet valves are kept closed. However, all of these measures significantly delay the starting of the internal combustion engine and give rise to a very complicated sequence. It is therefore necessary, inter alia, to perform open-loop or closed-loop control of the torque of the electric motor, which requires a large amount of effort.

A method of the generic type is described in published, non-prosecuted German patent application DE 10 2006 014 758 A1. In this document, an additional pressure accumulator is provided which serves to fill the hydraulic system when the internal combustion engine starts. However, such an additional pressure accumulator considerably increases the costs, which are also increased by the additional spring elements, nonreturn valves, throttles and the like which are required to operate the

additional pressure accumulator. A very large disadvantage of this method is also that the pressure accumulator must first be charged before the hydraulic system can be supplied with hydraulic medium.

### SUMMARY OF THE INVENTION

It is accordingly an object of the invention to provide a method for starting an internal combustion engine which overcomes the above-mentioned disadvantages of the prior art methods of this general type, in which the shortest possible time period occurs between the initiation of the starting process via the driver and the starting of the motor vehicle which is equipped with the internal combustion engine.

With the foregoing and other objects in view there is provided, in accordance with the invention a method for starting an internal combustion engine of a motor vehicle connected to a transmission via a starting device and operated in a start/stop operating mode. The method includes feeding a hydraulic medium to the starting device via a valve device by a hydraulic pump. Before the internal combustion engine is started by a starter, a control unit actuates the valve device such that the valve device enables delivery of the hydraulic medium to the starting device. The control unit further actuates the hydraulic pump such that during a starting of the internal combustion engine the hydraulic pump delivers the hydraulic medium directly into the starting device to bring about a mechanical operative connection between the internal combustion engine and the transmission via the starting device.

According to the present invention, the valve device which leads to the hydraulic pump is already enabled before the starting of the internal combustion engine, as a result of which the hydraulic pump can already deliver the hydraulic medium into the starting device during the starting of the internal combustion engine. As a result, the hydraulic medium can already be used to fill the starting device when the starting begins, that is to say at very low rotational speeds of the starter which is used to start the internal combustion engine. The hydraulic medium which is delivered by the hydraulic pump during the starting process is used here directly for the starting device without a pressure accumulator or the like having to be first filled. This leads to a situation in which during the starting of the internal combustion engine the mechanical operative connection can already be brought about between the internal combustion engine and the transmission so that the motor vehicle which is equipped with the internal combustion engine can start considerably more quickly than is the case with known solutions. According to the invention, the starting of the internal combustion engine and the filling of the starting device therefore take place simultaneously.

As a result of this parallel sequence, the internal combustion engine can be started without a delay, wherein the ignition process of the internal combustion engine is neither delayed nor impeded by the procedure according to the invention. Instead, the starting process of the internal combustion engine is even made easier to a certain extent since the hydraulic medium is delivered into the starting device, as a result of which the system pressure and therefore also the resistance during the starting process are reduced.

As a result of dispensing with additional auxiliary components, which is made possible by the method according to the invention, there can be a saving in both costs and installation space and a simpler device and a simpler method sequence are obtained than with the known solutions. It is also possible to dispense with, inter alia, an electric motor which assists the hydraulic pump, or a starter/generator since with the method according to the invention the starting of the internal combustion engine is performed by the starter which is already present. In this context, there is advantageously no need for closed-loop or open-loop control of the starter.

Very rapid actuation of the valve device can occur in one advantageous refinement of the invention if the control unit energizes the valve device by a CAN message before the starting of the internal combustion engine.

It is preferable that oil is used as the hydraulic medium and that a wet clutch is used as the starting device.

Other features which are considered as characteristic for the invention are set forth in the appended claims.

Although the invention is illustrated and described herein as embodied in a method for starting an internal combustion engine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

BRIEF DESCRIPTION OF THE SEVERAL VIEWS OF THE DRAWING

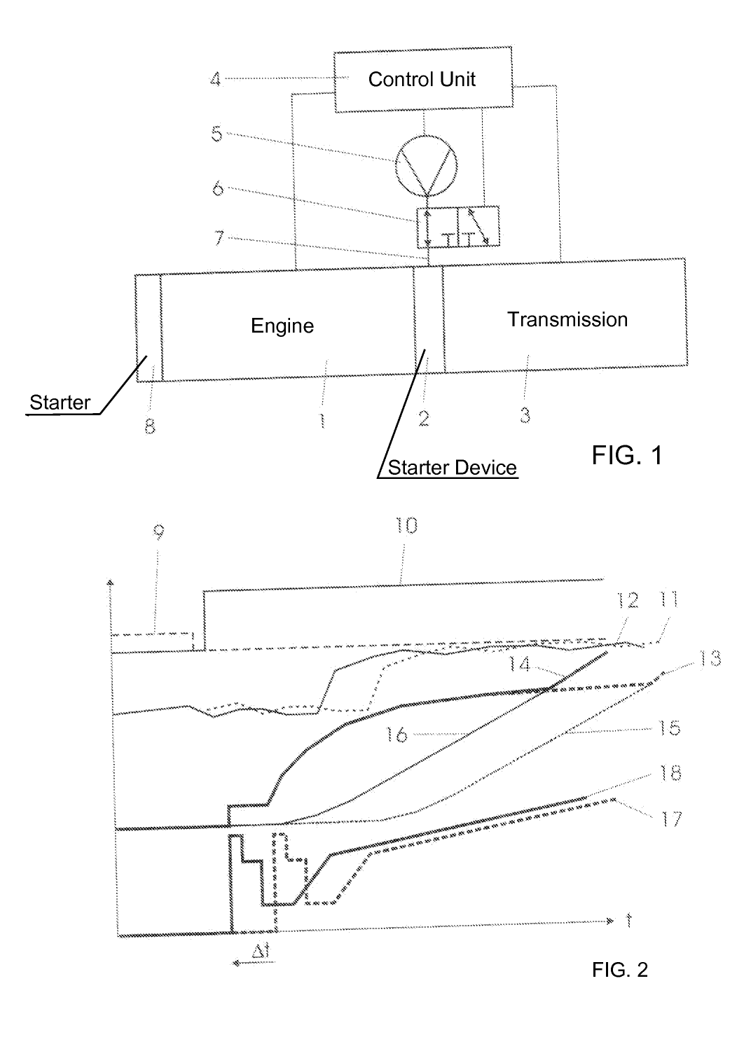

FIG. 1 is a schematic illustration of components used to carry out a method according to the invention and of the wiring thereof; and

FIG. 2 is a graph showing effects of the method according to the invention during a starting process of an internal combustion engine, compared to a method according to the prior art.

### DETAILED DESCRIPTION OF THE INVENTION

Referring now to the figures of the drawing in detail and first, particularly, to FIG. 1 thereof, there is shown a schematic illustration of an internal combustion engine 1 which is connected to a transmission 3, in the described exemplary embodiment preferably to an automatic transmission, via a starting device 2 which is embodied in the present case as a wet clutch. Since the components which are illustrated in FIG. 1 may be of a configuration which is known per se, more details are not provided on the components.

Both the internal combustion engine 1 and the transmission 3 are connected to a control unit 4 which is also connected to a hydraulic pump 5 and to a valve device 6. The valve device 6 is illustrated in the present case as a 3/2 way valve, but such an embodiment of the valve device 6 is to be considered as purely exemplary, and various other valve devices 6 could be used to conduct a volume flow of a hydraulic medium, preferably oil, generated by the hydraulic pump 5, to the starting device 2 via a line 7 through the valve device 6.

The internal combustion engine 1 is operated in a start/stop operating mode, i.e. the internal combustion engine 1 is shut down in the stationary state of a motor vehicle (not illustrated) which is equipped with the internal combustion engine 1 and, if appropriate, when further conditions, which may, however, be generally known, are met. As soon as the internal combustion engine 1 receives a message or notification that it is to be started again and the motor vehicle is to be activated, a method which is described below for starting the internal combustion engine 1 is carried out. The notification for starting the internal combustion engine 1 can originate, for example, from a non-illustrated accelerator which can also be connected to the control unit 4. The internal combustion engine 1 is started in a manner known per se by a starter 8, wherein, before the starting of the internal combustion engine 1, the control unit 4 actuates the valve device 6 in such a way that it enables feeding of the hydraulic medium to the starting device 2, i.e. the control unit 4 moves the valve device 6 into the position illustrated in FIG. 1 in which the hydraulic pump 5 is connected to the starting device 2 via the valve device 6. Furthermore, the control unit 4 actuates the hydraulic pump 5 in such a way that, during the starting of the internal combustion engine 1, the hydraulic pump delivers the hydraulic medium directly, i.e. without a device which is arranged therebetween, into the starting device 2, preferably already when the starting of the internal combustion engine 1 begins. The valve device 6 can be enabled by the control unit 4 by a CAN message before the internal combustion engine 1 starts.

As is apparent from the illustration in FIG. 1, the hydraulic pump 5 is not provided with any auxiliary measures whatsoever, i.e. it brings about the volume flow, necessary to fill the starting device 2, of the hydraulic medium without auxiliary devices. For this purpose, the hydraulic pump 5 can be driven by the internal combustion engine 1 in a way which is not illustrated but is known per se, for example by virtue of the fact that the hydraulic pump 5 is integrated into a valve drive which is driven by the crankshaft of the internal combustion engine 1. As a result, the first revolution of the internal combustion engine 1 after the starting thereof already actuates the hydraulic pump 5 and conveys the hydraulic medium into the starting device 2. A volume flow which proceeds from the hydraulic pump 5 in this context and/or a pressure which is generated by the hydraulic pump 5 can be regulated in such a way that it approaches a previously set target pressure asymptotically from below. Upwards transgression of this target pressure, which could arise, for example, due to overfilling of the starting device 2 and which possibly leads to a starting jolt, is ruled out owing to the low pump delivery capacity which results as a result of the low rotational speeds of the starter 8, which occur in a range up to 300 rpm. As a result, open-loop or closed-loop control inaccuracies which can arise as a result of an excessively long filling period with an excessively high prefilling pressure, are avoided and the starting jolt from the motor vehicle start is reduced. The volume of oil which is delivered at the specified rotational speeds is generally sufficient to be able to fill the starting device 2 while the starter 8 is turning. After the internal combustion engine 1 fires, the rotational speed thereof increases to the idling speed. If the filling of the starting device 2 with the hydraulic medium is not yet completely finished by the time the internal combustion engine 1 fires, the remaining filling occurs due to the relatively high rotational speed of the internal combustion engine 1, which can then also rise above the idling speed. During filling of the starting device 2 with the hydraulic medium, the starting device 2 can build up a momentum in order to bring about the mechanical operative connection between the internal combustion engine 1 and the transmission 2, and ensure that the motor vehicle starts.

FIG. 2 illustrates the advantages of the method described above over known methods by use of a diagram. The lines 9-18 show various operating states of components of the motor vehicle or of the internal combustion engine 1 plotted over the time t. In this context, the dashed line which is denoted by the reference symbol 9 represents the position of the brake, while the line which is denoted by the reference symbol 10 represents the position of the accelerator pedal of the motor vehicle. The dashed line 11 illustrates the acceleration of the motor vehicle according to a method which is known from the prior art, while the line which is denoted by the reference symbol 12 represents the acceleration of the motor vehicle with the method according to the invention. The dashed line which is denoted by the reference symbol 13 represents the profile of the rotational speed of the internal combustion engine 1 according to a method which is known from the prior art, and the line which is denoted by the reference symbol 14 denotes the rotational speed of the internal combustion engine 1 with the method according to the invention. The dashed line which is denoted by the reference symbol 15 represents the input rotational speed of the transmission 3 in a method which is known from the prior art, and the line which is denoted by the reference symbol 16 denotes the input rotational speed of the transmission 3 according to the inventive method. Finally, the dashed line which is provided with the reference symbol 17 represents the setpoint pressure of the starting device 2 according to a method which is known from the prior art, while the line which is denoted by the reference symbol 18 represents the setpoint pressure of the starting device 2 with the method according to the invention.

It is clearly apparent from the diagram that both the pressure which is present at the starting device 2 and the increase in the input rotational speed of the transmission 3, and finally also the acceleration of the motor vehicle, are advanced considerably by a time ^{•}t, i.e. that the acceleration of the motor vehicle, the input rotational speed of the transmission 3 and the pressure at the starting device 2 are increased at an earlier time. In other words, the reaction time when the internal combustion engine 1 starts is reduced considerably by the method according to the invention.

1. A method for starting an internal combustion engine of a motor vehicle connected to a transmission via a starting device and operated in a start/stop operating mode, which comprises the steps of:
feeding a hydraulic medium to the starting device via a valve device by a hydraulic pump via the further steps of:
before the internal combustion engine is started by a starter, actuating, via a control unit, the valve device such that the valve device enables delivery of the hydraulic medium to the starting device; and
actuating, via the control unit, the hydraulic pump such that during a starting of the internal combustion engine the hydraulic pump delivers the hydraulic medium directly into the starting device to bring about a mechanical operative connection between the internal combustion engine and the transmission by means of the starting device.

2. The method according to claim 1, which further comprises energizing, via the control unit, the valve device by means of a CAN message before and during the starting of the internal combustion engine.

3. The method according to claim 1, which further comprises using oil as the hydraulic medium.

4. The method according to claim 1, which further comprises providing a wet clutch as the starting device.

5. The method according to claim 1, which further comprises using the hydraulic medium to fill the starting device when the starting of the internal combustion engine begins.

6. The method according to claim 1, wherein the hydraulic pump brings about a volume flow of the hydraulic medium necessary to fill the starting device, without using auxiliary devices.

7. The method according to claim 1, which further comprises driving the hydraulic pump by the internal combustion engine, wherein a first revolution of the internal combustion engine after the starting thereof, already drives the hydraulic pump and delivers the hydraulic medium into the starting device.

8. The method according to claim 1, which further comprises regulating a pressure of the hydraulic medium which is generated by the hydraulic pump in such a way that it approaches a target pressure asymptotically from below.
